(19) United States
(12) Patent Application Publication
(10) Pub. No.: US 2016/0064971 A1
(43) Pub. Date: Mar. 3, 2016

(54) Charging Device and Charging Method

(71) Applicant: Acer Inc., New Taipei City (TW)

(72) Inventor: Jing-Jhe Dai, New Taipei City (TW)

(21) Appl. No.: 14/623,580

(22) Filed: Feb. 17, 2015

(30) Foreign Application Priority Data
Sep. 2, 2014 (TW) 103130315

(51) Int. Cl. H02J 7/00

(52) U.S. Cl. CPC H02J 7/0021; H02J 7/007

(57) ABSTRACT

A charging device and a charging method are disclosed, wherein the charging device for charging multiple electronic devices has a plurality of power connectors, a battery level monitor module, a power module, and a control module. The plurality of power connectors are coupled to the multiple electronic devices. The battery level monitor module monitors the battery level of each electronic device connected to the plurality of power connectors. The power module charges the multiple electronic devices. The control module is signally connected with the plurality of power connectors, the battery level monitor module, and the power module, and adjusts the charging current supplied to each electronic device according to the battery level of each electronic device.

### BACKGROUND OF THE INVENTION

1. Field of the Invention

The present invention relates to a charging device and a charging method, and particularly to a charging device and a charging method by which the amount of a charging current is supplied to the electronic device according to the battery level of the electronic device.

2. Description of the Related Art

With the prevalence and popularity of handheld devices, modern life is almost inseparable from the smart phone or tablet PC. However, in view of electricity storage of the battery loaded on the current smart phone or tablet PC, electricity shortages of the smart phone or tablet PC often occur after prolonged use of such devices. Because of this, such devices must be charged every day. Current charging devices usually provide a plurality of power connectors for charging the smart phone or tablet PC, and each power connector has a fixed current limit. When the battery level of the smart phone or tablet PC is too low and the user happens to plug a low power device into a power connector with the lower current limit, the problem of charging too slowly occurs. Thus, there is a need for improvement.

### SUMMARY OF THE INVENTION

It is an objective of the present invention to provide a charging device by which the amount of charging current is supplied to the electronic device according to the battery level of the electronic device.

It is another objective of the present invention to provide a charging method by which the amount of charging current is supplied to the electronic device according to the battery level of the electronic device.

To achieve the objectives described above, the charging device of the present invention includes a plurality of power connectors, a battery level monitor module, a power module, and a control module. The plurality of power connectors are coupled to a plurality of electronic devices respectively. The battery level monitor module is used to monitor the battery level of each electronic device coupled to each power connector. The power module is coupled to the plurality of power connectors to charge each electronic device through the plurality of power connectors. The control module is signally connected to the plurality of power connectors, the battery level monitor module, and the power module, respectively, and used to adjust the amount of charging current supplied by the power module to each electronic device according to the battery level of each electronic device.

The present invention further provides a charging method, which is used in a charging device coupled to a plurality of electronic devices such that the charging device charges the plurality of electronic devices. The charging method includes the following steps: monitoring the battery level of each electronic device coupled to a charging device; and adjusting the charging current corresponding to each electronic device supplied by the power module according to the battery level of each electronic device.

### BRIEF DESCRIPTION OF THE DRAWINGS

FIG. 1 is a hardware architecture diagram of a charging device according to the present invention;

FIG. 2 is a flowchart showing a charging method according to an embodiment of the present invention; and

FIG. 3 is a flowchart showing a charging method according to another embodiment of the present invention.

### DETAILED DESCRIPTION OF THE PREFERRED EMBODIMENT

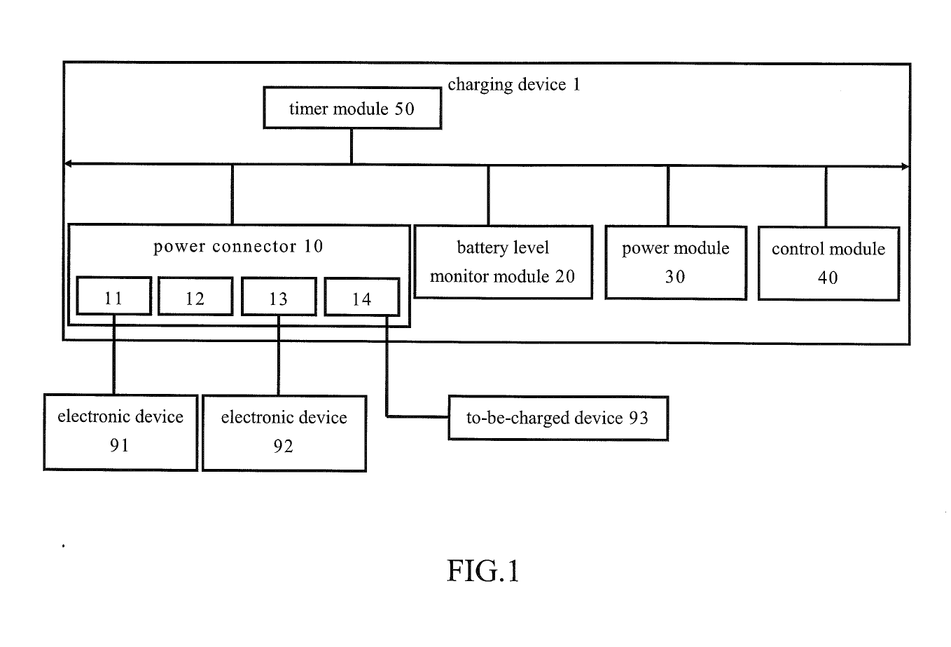

The technical content of the present invention will be better understood with reference to preferred embodiments. Please refer to FIG. 1 for a hardware architecture diagram of a charging device according to the present invention.

As shown in FIG. 1, according to an embodiment of the present invention, a charging device 1 of the present invention is used to charge electronic devices 91, 92, respectively. The charging device 1 comprises a plurality of power connectors 10, a battery level monitor module 20, a power module 30, a control module 40, and a timer module 50. In the present embodiment, the charging device 1 is a power bank, and the electronic devices 91, 92 may be an electronic device, such as another power bank, a smartphone, or a tablet computer, but the present invention is not limited to the aforementioned embodiment.

In the present embodiment, the charging device 1 of the present invention is provided with four power connectors 11, 12, 13, and 14, which are all USB (Universal Serial Bus) connectors, to be coupled to the electronic devices 91 and 92. As shown in FIG. 1, the electronic device 91 is coupled to the power connector 11, and the electronic device 92 is coupled to the power connector 13. After the electronic devices 91 and 92 are coupled to the power connectors 11 and 13 respectively, the battery level monitor module 20 monitors and acquires the battery levels of each of the electronic devices 91 and 92, which serve as the basis for the charging device 1 to distribute charging current. It is noted that the term “battery level” refers to the percentage of the total capacity of the battery which is occupied by an electrical charge.

According to a specific embodiment of the present invention, the battery level monitor module 20 can be signally connected with the operating system (OS) of the electronic device 91 through the power connector 11 to acquire the battery level of the electronic device 91. Similarly, the battery level monitor module 20 can be signally connected with the operating system (OS) of the electronic device 92 through the power connector 13 to acquire the battery level of the electronic device 92. It should be noted that the method of acquiring the battery levels of the electronic devices 91 and 92 through the battery level monitor module 20 is not limited to the present embodiment. The battery level monitor module 20 can be a hardware device, software program, firmware, or a combination of these, or configured as a circuit or in any other appropriate pattern.

The power module 30 is a built-in battery in the charging device 1 for storing electrical energy. The power module 30 can be charged using the normal power supply and then charge the electronic devices 91, 92. The control module 40 is signally connected with the power connectors 11, 12, 13, and 14, the battery level monitor module 20, the power module 30, and the timer module 50, respectively. After acquiring the battery levels of the electronic devices 91, 92 from the battery level monitor module 20, the control module 40 adjusts the amounts of charging current supplied by the power module 30 to each of the electronic devices 91, 92 according to the battery levels of the electronic devices 91, 92 and then provides the greater amount of charging current to the electronic device with the relatively lower battery level.

For example, assuming the total charging current provided by the power module 30 is 2 A, the battery level of the electronic device 91 acquired by the battery level monitor module 20 is 30% of the total capacity of the battery in the electronic device 91, and the battery level of the electronic device 92 acquired by the battery level monitor module 20 is 60% of the total capacity of the battery in the electronic device 92. In accordance with the aforementioned data, the battery level of the electronic device 91 is in a relatively lower state. At this time, the control module 40 allows the power module 30 to preferentially provide the greater amount of charging current to the electronic device 91, such as providing a charging current of 1.5 A, such that the electronic device 91 can be quickly charged. Meanwhile, the control module 40 allows the power module 30 to provide the remaining charging current of 0.5 A to the electronic device 92. It should be noted that the control module 40 can be a control chip, a processor, or any other hardware device, software program, firmware with control capability or a combination of these.

According to an embodiment of the present invention, in the process the charging device 1 of the present invention charging the electronic devices 91, 92, the battery level monitor module 20 monitors and acquires the battery levels of each of the electronic devices 91, 92 in real time to provide the real-time battery levels of the electronic devices 91, 92 respectively. After the pre-determined period of time (e.g., 15 minutes) measured by the timer module 50 is reached, the control module 40 dynamically adjusts the amount of charging current of each of the electronic devices 91, 92 supplied by the power module 30 according to the real-time battery levels of each electronic device 91, 92 to provide the greater amount of charging current to the electronic device with the relatively lower real-time battery level.

For illustration, assume that the charging device 1 of the present invention keeps charging the electronic devices 91, 92 for a pre-determined period of time (e.g., 15 minutes), and then the battery level monitor module 20 acquires the real-time battery levels of the electronic devices 91, 92. Before the charging device 1 starts to charge the electronic device 91, the battery level of the electronic device 91 is 30% of the total capacity of the battery capacity in the electronic device 91. After the charging device 1 charges the electronic device 91 at the charging current of 1.5 A for 15 minutes, the battery level of the electronic device 91 increases from the original 30% to 95% (95% is the real-time battery level of the electronic device 91).

In addition, after the charging device 1 charges the electronic device 92 at the charging current of 0.5 A for 15 minutes, the battery level of the electronic device 92 increases from the original 60% to 75% (75% is the real-time battery level of the electronic device 92). At this time, the battery of the electronic device 91 is close to full capacity, while the real-time battery level of the electronic device 92 is in a relatively lower state. At this time, the control module 40 will dynamically increase the charging current supplied by the power module 30 to the electronic device 92, such as increasing the charging current supplied to the electronic device 92 from the original 0.5 A to 1 A to improve the charging speed of the electronic device 92. Due to the limit of the total charging current of the power module 30, the charging current supplied by the power module 30 to the electronic device 91 is decreased from the original 1.5 A to 1 A. It should be noted that the current distribution value and time settings described above are merely illustrative, and the present invention is not limited thereto, as long as the objective of providing the greater amount of charging current to the device with the relatively lower battery level can be achieved.

Please refer to FIG. 1 again; according to an embodiment of the present invention, in the process of charging the electronic devices 91, 92 through the charging device 1 of the present invention, if the charging device 1 is also coupled to a to-be-charged device 93, the battery level monitor module 20 will immediately monitor and acquire the real-time battery levels of the electronic devices 91, 92 and the to-be-charged device 93 at the same time, such that the control module 40 re-adjusts the amount of charging current supplied by the power module 30 to the electronic devices 91, 92 and to the to-be-charged device 93 according to the real-time battery levels of the electronic devices 91, 92 and the battery level of the to-be-charged device 93 to provide the greater amount of charging current to the device with a relatively lower or lowest battery level.

For illustration, assume that while the charging device 1 of the present invention continues to charge the electronic devices 91, 92, the to-be-charged device 93 is coupled to the power connector 14. At this time, the battery level monitor module 20 will acquire the real-time battery levels of the electronic devices 91, 92 and the battery level of the to-be-charged device 93. For example, the real-time battery level of the electronic device 91 measured by the battery level monitor module 20 is 60%, the real-time battery level of the electronic device 92 is 65%, and the battery level of the to-be-charged device 93 is 10%. At this time, since the battery level of the to-be-charged device 93 is the lowest one, the control module 40 will dynamically increase the charging current supplied by the power module 30 to the to-be-charged device 93, e.g., charging the to-be-charged device 93 with a current of 1 A. Due to the limit of the total charging current of the power module 30, after the charging current of each electronic device 91, 92 is adjusted to 0.5 A, the timer module 50 counts to zero and re-starts counting. After the pre-determined period of time is reached, the real-time battery levels of the electronic devices 91, 92 and the to-be-charged device 93 will be acquired again. Then, the aforementioned steps will be repeated to re-distribute the charging current. It should be noted that the current distribution settings described above are merely illustrative, and that the present invention is not limited thereto.

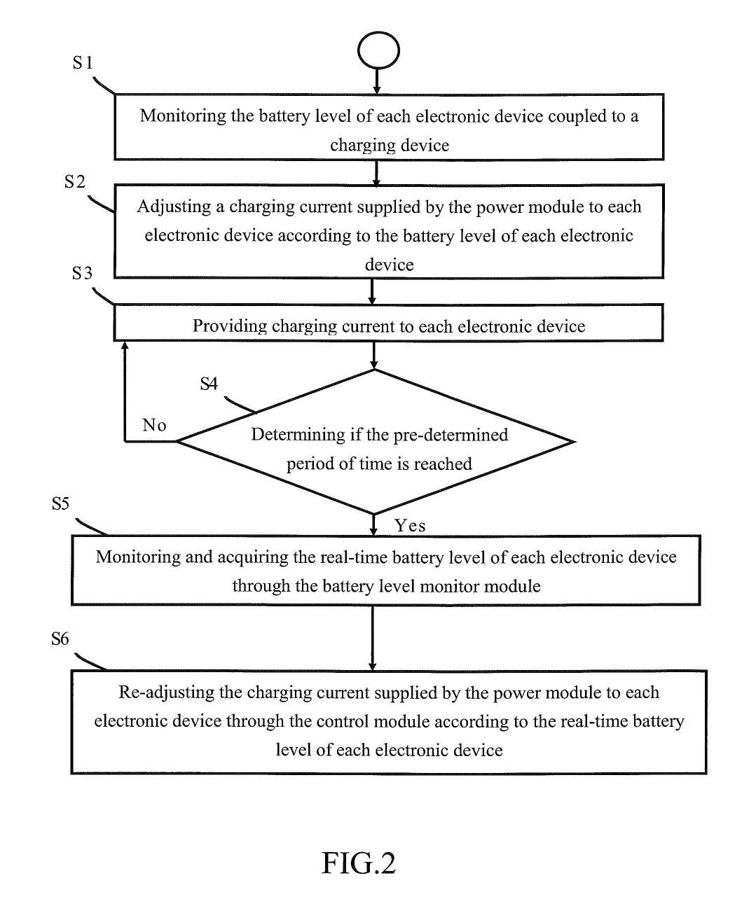

Please refer to FIG. 2; along with FIG. 1, wherein FIG. 2 is a flowchart showing a charging method according to an embodiment of the present invention. It should be noted that the charging method of the present invention is applied to the charging device 1. According to a specific embodiment of the present invention, the charging device 1 is a power bank. As shown in FIG. 2, the charging method in the present invention comprises Step S1 to Step S5. Each step will be described in detail hereinafter.

Step S1: Monitoring the battery level of each electronic device coupled to a charging device.

In the present embodiment, the user can connect the electronic devices 91, 92 to the power connectors 11, 13 of the charging device 1. At this time, the battery level monitor module 20 monitors and acquires the battery levels of each of the electronic devices 91, 92, which serve as the basis for the charging device 1 to distribute charging current. According to a specific embodiment of the present invention, the battery level monitor module 20 can be connected to the operating system (OS) signal of the electronic device 91 through the power connector 11, and connected to the operating system (OS) signal of the electronic device 92 through the power connector 13 to acquire the battery levels of the electronic devices 91, 92, respectively.

Step S2: Adjusting a charging current supplied by the power module to each electronic device according to the battery level of each electronic device.

After the battery level monitor module 20 acquires the battery levels of the electronic devices 91, 92, the control module 40 adjusts the amount of charging current supplied by the power module 30 to each of the electronic devices 91, 92 according to the battery levels of the electronic devices 91, 92 in order to provide the greater amount of charging current to the electronic device with the relatively lower battery level. Step S3: Providing charging current to each electronic device.

Step S4: Determining if the pre-determined period of time is reached.

In the process of charging the electronic devices 91, 92 through the charging device 1 of the present invention, if the pre-determined period of time (e.g., 15 minutes) is reached, Step S5 is performed; if the pre-determined period of time is not reached, Step S3 continues.

Step S5: Monitoring and acquiring the real-time battery level of each electronic device through the battery level monitor module.

According to an embodiment of the present invention, in the process of charging the electronic devices 91, 92 through the charging device 1 of the present invention, after a pre-determined period of time (e.g., 15 minutes) is reached, the battery level monitor module 20 monitors and acquires the real-time battery levels of the electronic devices 91, 92 to provide the real-time battery levels of each of the electronic devices 91, 92.

Step S6: Re-adjusting the charging current supplied by the power module to each electronic device through the control module according to the real-time battery level of each electronic device.

Then, the control module 40 dynamically adjusts the amount of charging current of each of the electronic devices 91, 92 supplied by the power module 30 according to the real-time battery levels of the electronic devices 91, 92 to provide the greater amount of charging current to the electronic device with the relatively lower battery level.

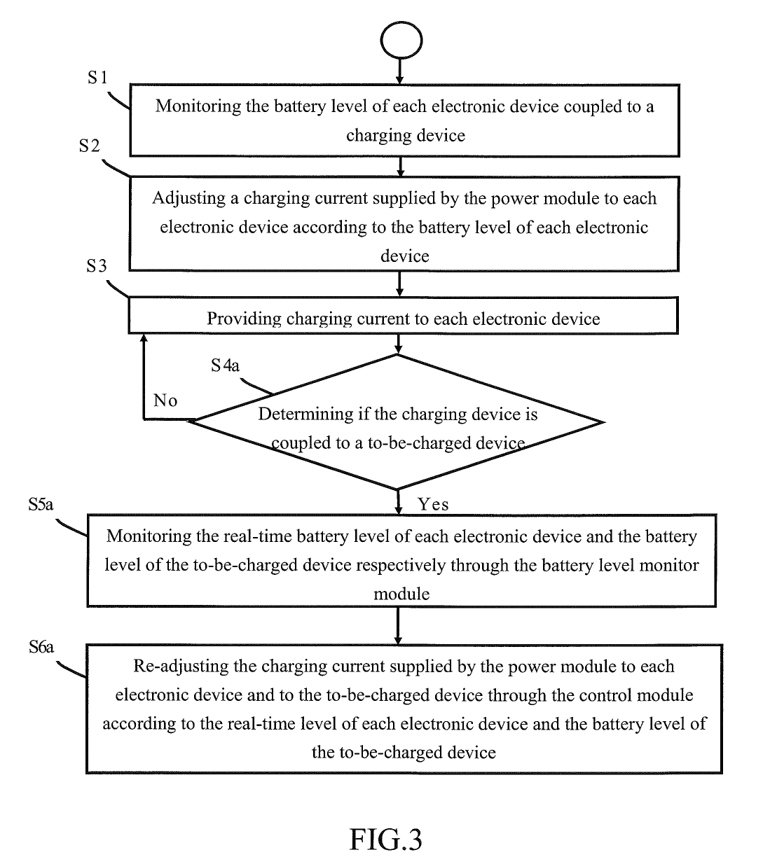

Please refer to FIG. 3; along with FIG. 1, wherein FIG. 3 is a flowchart showing a charging method according to another embodiment of the present invention. As shown in FIG. 2, the charging method in the present invention comprises Step S1, Step S2, Step S3, and Step S4a to Step 6a. It should be noted that since the difference between the present embodiment and the aforementioned embodiment regarding the charging method is the inclusion of Step S3a to Step S5a, while the remaining steps are the same, only Step S3a to Step S5a will be described hereinafter. Please refer to the description about the aforementioned embodiment for Step S1 and Step S2.

Step S4a: Determining if the charging device is coupled to a to-be-charged device.

In the process of charging the electronic devices 91, 92 through the charging device 1 according to the present invention, if the charging device 1 is also coupled to a to-be-charged device 93, Step S4a is performed; if the charging device 1 is not connected to the to-be-charged device 93, Step S2 continues.

Step S5a: Monitoring the real-time battery level of each electronic device and the battery level of the to-be-charged device respectively through the battery level monitor module.

Assuming that in the process of continuously charging the electronic devices 91, 92 through the charging device 1 of the present invention, the to-be-charged device 93 is coupled to the power connector 14. At this time, the battery level monitor module 20 will acquire the real-time battery levels of the electronic devices 91, 92 and the battery level of the to-be-charged device 93. For example, the real-time battery level of the electronic device 91 measured by the battery level monitor module 20 is 60%, the real-time battery level of the electronic device 92 is 65%, and the battery level of the to-be-charged device 93 is 10%.

Step S6a: Re-adjusting the charging current supplied by the power module to each electronic device and to the to-be-charged device through the control module according to the real-time level of each electronic device and the battery level of the to-be-charged device.

For example, assuming that in the process of continuously charging the electronic devices 91, 92 through the charging device 1 of the present invention, the to-be-charged device 93 is coupled to the power connector 14. At this time, the battery level monitor module 20 will acquire the real-time battery levels of the electronic devices 91, 92 and the battery level of the to-be-charged device 93, such that the control module 40 can re-adjust the power supply status of the power module 30, which allows the power module 30 to provide the greater amount of charging current to the device with the relatively lower or lowest battery level. If it is shown in Step S4a that the to-be-charged device 93 has the relatively lowest battery level among the electronic devices 91, 92 and the to-be-charged device 93, the control module 40 will dynamically increase the charging current supplied by the power module 30 to the to-be-charged device 93, e.g., charging the to-be-charged device 93 at the rate of 1 A. Due to the limit of the total charging current of the power module 30, the charging current of each of the electronic devices 91, 92 will be adjusted to 0.5 A.

Through this design, the charging device 1 of the present invention can adjust the amount of charging current supplied to the electronic devices 91, 92 in real time according to the power status of the electronic devices 91, 92. This not only improves the charging speed of the electronic devices 91, 92 but also solves the problem of limiting the charging speed of the to-be-charged device coupled to a power connector because the power connector can only provide a single amount of current.

It should be noted that the described embodiments are not necessarily exclusive, and various changes and modifications may be made to the described embodiments without departing from the scope of the invention as disposed by the appended claims.

What is claimed is:

1. A charging device for charging a plurality of electronic devices respectively comprising:
a plurality of power connectors, which can be coupled to the plurality of electronic devices, respectively;
a battery level monitor module, which is used to monitor and acquire a battery level of each electronic device coupled to the power connectors, respectively;
a power module, which is coupled to the plurality of power connectors to charge each of the electronic devices through the plurality of power connectors individually; and
a control module, which is signally connected with the plurality of power connectors, the battery level monitor module, and the power module, respectively, and adjusts an amount of a charging current supplied by the power module to each of the electronic devices according to the battery level of each electronic device.

2. The charging device as claimed in claim 1, wherein the power module supplies a greater amount of the charging current to the electronic device with the relatively lower battery level among the plurality of electronic devices.

3. The charging device as claimed in claim 2, wherein the charging device comprises a timer module for determining if a pre-determined period of time is reached, after the pre-determined period of time is reached, the battery level monitor module re-acquires a real-time battery level of each electronic device.

4. The charging device as claimed in claim 3, after the battery level monitor module re-acquires a real-time battery level of each electronic device ,the control module dynamically adjusts the amount of the charging current supplied by the power module to each electronic device according to the real-time battery level of each electronic device in order to provide the greater amount of the charging current to the electronic device with the relatively lower real-time battery level among the plurality of electronic devices.

5. The charging device as claimed in claim 2, wherein during the charging process, if the charging device is coupled to a to-be-charged device, the battery level monitor module acquires a real-time battery level of each electronic device and the battery level of the to-be-charged device at the same time, such that the control module re-adjusts the amount of the charging current supplied by the power module to each of the electronic devices and the to-be-charged devices according to the real-time battery level of each electronic device and the battery level of the to-be-charged device.

6. A charging method used in a charging device coupled to a plurality of electronic devices, the charging method comprising the following steps:
monitoring and acquiring a battery level of each electronic device coupled to the charging device; and
adjusting an amount of a charging current supplied to each electronic device according to the battery level of each electronic device.

7. The charging method as claimed in claim 6, wherein a greater amount of the charging current to the electronic device with the relatively lower battery level among the plurality of electronic devices.

8. The charging method as claimed in claim 6, the charging method further comprising the following steps:
determining if the charging device is coupled to a to-be-charged device.

9. The charging method as claimed in claim 8, further comprising:
if the determining result is yes, monitoring and acquiring a real-time battery level of each electronic device and the battery level of the to-be-charged device; and
re-adjusting the amount of the charging current supplied to each electronic device and to the to-be-charged device according to the battery level of each electronic device and the battery level of the to-be-charged device.

10. The charging method as claimed in claim 6, the charging method further comprising the following steps:
re-acquiring the battery level of the electronic device in real time after a predetermined time is reached; and
dynamically adjusting the amount of the charging current supplied to each electronic device according to the real-time battery level of each electronic device to provide the greater amount of the charging current to the electronic device with a relatively lower real-time battery level among the plurality of electronic devices.

11. The charging method as claimed in claim 7, the charging method further comprising the following steps:
re-acquiring the battery level of the electronic device in real time after a predetermined time is reached; and
dynamically adjusting the amount of charging current supplied to each electronic device according to the real-time battery level of each electronic device to provide the greater charging current to the electronic device with the relatively lower real-time battery level among the plurality of electronic devices.
